(19) United States
(12) Patent Application Publication
(10) Pub. No.: US 2021/0166265 A1
(43) Pub. Date: Jun. 3, 2021

(54) INFORMATION OUTPUT DEVICE, METHOD, AND PROGRAM

(71) Applicant: NIPPON TELEGRAPH AND TELEPHONE CORPORATION, Tokyo (JP)

(72) Inventors: Yasunori OZAKI, Musashino-shi, Tokyo (JP); Tatsuya ISHIHARA, Musashino-shi, Tokyo (JP); Narimune MATSUMURA, Musashino-shi, Tokyo (JP); Tadashi NUNOBIKI, Musashino-shi, Tokyo (JP)

(73) Assignee: NIPPON TELEGRAPH AND TELEPHONE CORPORATION, Tokyo (JP)

(21) Appl. No.: 17/265,773

(22) PCT Filed: Aug. 5, 2019
(86) PCT No.: PCT/JP2019/030743

§ 371 Date: Feb. 3, 2021

(30) Foreign Application Priority Data
Aug. 6, 2018 (JP) 2018-147907

(51) Int. Cl. G06Q 30/02; G06T 7/70; G06K 9/00; G06N 20/00

(52) U.S. Cl. CPC G06Q 30/0251; G06T 7/70; G06K 9/00268; G06K 2009/00322; G06N 20/00; G06T 2207/10016; G06T 2207/30201; G06K 9/00335

(57) ABSTRACT

An information output apparatus according to an embodiment includes: first estimation means for estimating an attribute indicating a feature unique to a user, based on video data; second estimation means for estimating a current action state of the user, based on face orientation data and position data of the user; determination means for, in an action-merit table that defines combinations each composed of an action for inducing a user to use a service according to an attribute and a state, and a value indicating a magnitude of a merit of the action, determining an action for inducing the user to use a service with a high value indicating the magnitude of the merit of the action, out of combinations corresponding to the estimated attribute and state; setting means for setting a reward value for the action, based on action states estimated; setting means for setting a reward value for the action, based on action states estimated before and after the action; and update means for updating the value of the action merit, based on the reward value.

### TECHNICAL FIELD

An embodiment of the present invention relates to an information output apparatus, a method, and a program.

### BACKGROUND ART

Recently, robots or signages are arranged as agents instead of reception clerks at receptions for dealing with visitors, and such agents perform reception service. Examples of the reception service also include an operation to talk to users (e.g., pedestrians) (see NPL 1, for example).

Conventionally, when agents talk to users, an approach of a user is detected using a distance sensor, and an agent or the like talks to the user through the detection.

### CITATION LIST

### Non Patent Literature

[NPL 1] Yasunori Ozaki and seven others “A interactive digital signage system with a virtual agent and multiple devices to facilitate uses by pedestrians in the real world” IEICE Technical Report vol. 116, no. 461, pp. 111-118, Feb. 18, 2017

### SUMMARY OF THE INVENTION

### Technical Problem

In order to enable an agent to attract pedestrians, it is necessary to induce pedestrians by giving stimulation such as talking to the pedestrians.

On the other hand, it has been made clear from experimental results that, if an agent gives stimulation to a pedestrian without consideration, the pedestrian feels displeasure.

The present invention has been made in view of the foregoing, and an object of the present invention is to provide an information output apparatus, a method, and a program capable of properly inducing a user to use a service.

### Means for Solving the Problem

In order to achieve the above-described object, a first aspect of an embodiment of the present invention is directed to an information output apparatus including: detection means for detecting face orientation data and position data regarding a user, based on video data regarding the user; first estimation means for estimating an attribute indicating a feature unique to the user, based on the video data; second estimation means for estimating a current action state of the user, based on the face orientation data and the position data detected by the detection means; a storage unit having stored therein an action-merit table that defines combinations each composed of an action for inducing a user to use a service according to an attribute and an action state of the user, and a value indicating a magnitude of a merit of the action; determination means for determining an action for inducing the user to use a service with a high value indicating the magnitude of the merit of the action, out of combinations corresponding to the attribute estimated by the first estimation means and the state estimated by the second estimation means, in the action-merit table stored in the storage unit; output means for outputting information according to the action determined by the determination means; setting means for setting, after the information is output by the output means, a reward value for the determined action, based on action states of the user estimated by the second estimation means before and after the output; and update means for updating the value of the action merit in the action-merit table, based on the set reward value.

A second aspect of the present invention is directed to the information output apparatus according to the first aspect, wherein the setting means sets a positive reward value for the determined action, in a case in which a change from the action state of the user estimated by the second estimation means before the information is output by the output means to the action state of the user estimated by the second estimation means after the information is output by the output means is a change indicating that the output information is effective for the induction, and sets a negative reward value for the determined action, in a case in which a change from the action state of the user estimated by the second estimation means before the information is output by the output means to the action state of the user estimated by the second estimation means after the information is output by the output means is a change indicating that the output information is not effective for the induction.

A third aspect of the present invention is directed to the information output apparatus according to the second aspect, wherein the attribute estimated by the first estimation means includes an age of the user, and in a case in which the age of the user that is the attribute estimated by the first estimation means when the information is output by the output means is over a predetermined age, the setting means changes the set reward value to a value increased by an absolute value of the value.

A fourth aspect of the present invention is directed to the information output apparatus according to any one of the first to third aspects, wherein the output means outputs at least one of image information, audio information, and drive control information for driving an object according to the action determined by the determination means.

An aspect of an embodiment of the present invention is directed to an information output method that is performed by an information output apparatus, including: detecting face orientation data and position data regarding a user, based on video data regarding the user; estimating an attribute indicating a feature unique to the user, based on the video data; estimating a current action state of the user, based on the detected face orientation data and position data; in an action-merit table that is stored in a storage apparatus and that defines combinations each composed of an action for inducing a user to use a service according to an attribute and an action state of the user, and a value indicating a magnitude of a merit of the action, determining an action for inducing the user to use a service with a high value indicating the magnitude of the merit of the action, out of combinations corresponding to the estimated attribute and state; outputting information according to the determined action; setting, after the information is output according to the determined action, a reward value for the determined action, based on estimated action states of the user before and after the output; and updating the value of the action merit in the action-merit table, based on the set reward value.

An aspect of an embodiment of the present invention is directed to an information output processing program for causing a processor to function as the means of the information output apparatus according to any one of the first to fourth aspects.

### Effects of the Invention

With the first aspect of the information output apparatus according to the embodiment of the present invention, an action for inducing a user to use a service is determined based on a user's state and attribute and an action-merit function, a reward function is set based on a state of the user when information according to the determined operation is output, and the action-merit function is updated such that a more proper action can be determined in consideration of the reward function. Accordingly, for example, when attracting a user, an agent can perform a proper action to the user, and thus it is possible to properly induce the user to use a service.

With the second aspect of the information output apparatus according to the embodiment of the present invention, in a case in which a change from the action state of the user estimated before the information is output according to the determined action to the state estimated after the information is output is a change indicating that the information is effective for the induction, a positive reward value is set for the action, and, in a case in which the change is a change indicating that the information is not effective for the induction, a negative reward value is set for the action. Accordingly, it is possible to properly seta reward according to whether or not the information is effective for the induction.

With the third aspect of the information output apparatus according to the embodiment of the present invention, the attribute includes an age of the user, and, in a case in which the age estimated when the information is output according to the determined action is over a predetermined age, a value increased by an absolute value of the set reward is set. Accordingly, for example, it is possible to increase a reward for adults who react to actions rather insensitively, because it is considered that a significant user experience was given.

With the fourth aspect of the information output apparatus according to the embodiment of the present invention, at least one of image information, audio information, and drive control information for driving an object according to the determined action is output. Accordingly, it is possible to output proper information according to a service to which a user is intended to be induced.

That is to say, according to the present invention, it is possible to properly induce a user to use a service.

### BRIEF DESCRIPTION OF DRAWINGS

FIG. 1 is a block diagram showing an example of the hardware configuration of an information output apparatus according to an embodiment of the present invention.

FIG. 2 is a diagram showing an example of the software configuration of the information output apparatus according to the embodiment of the present invention.

FIG. 3 is a diagram showing an example of the functional configuration of a learning unit of the information output apparatus according to the embodiment of the present invention.

FIG. 4 is a table illustrating an example of definitions of a state set S.

FIG. 5 is a table illustrating an example of definitions of an attribute set P.

FIG. 6 is a diagram illustrating an example of definitions of an action set A.

FIG. 7 is a diagram showing an example of the configuration of an action-merit table in the form of a table.

FIG. 8 is a flowchart illustrating an example of the processing operation by the learning unit.

FIG. 9 is a flowchart illustrating an example of the processing operation of a thread “determine action from policy” by the learning unit.

FIG. 10 is a flowchart illustrating an example of the processing operation of a thread “update action-merit function” by the learning unit.

### DESCRIPTION OF EMBODIMENTS

Hereinafter, an embodiment of the present invention will be described with reference to the drawings.

### (Configuration)

### (1) Hardware Configuration

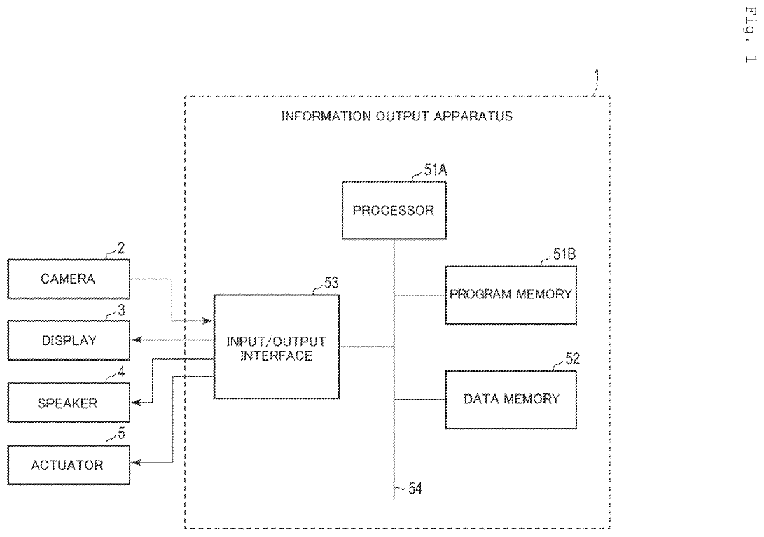

FIG. 1 is a block diagram showing an example of the hardware configuration of an information output apparatus 1 according to an embodiment of the present invention.

The information output apparatus 1 is constituted by, for example, a server computer or a personal computer, and has a hardware processor 51A such as a CPU (central processing unit). In the information output apparatus 1, a program memory 51B, a data memory 52, and an input/output interface 53 are connected via a bus 54 to the hardware processor 51A.

A camera 2, a display 3, a speaker 4 for outputting audio, and an actuator 5 are attached to the information output apparatus 1. The camera 2, the display 3, the speaker 4, and the actuator 5 can be connected to the input/output interface 53.

As the camera 2, for example, a solid-state image sensing device such as a CCD (charge coupled device) or a CMOS (complementary metal oxide semiconductor) sensor is used. As the display 3, for example, a liquid crystal display, an organic EL (electro luminescence) display, or the like is used. Note that the display 3 and the speaker 4 may be devices built in the information output apparatus 1, or devices of other apparatuses that can communicate with the information output apparatus 1 via a network may be used as the display 3 and the speaker 4.

The input/output interface 53 may include, for example, one or more wired or wireless communication interfaces. The input/output interface 53 inputs camera video captured by the attached camera 2 to the information output apparatus 1.

Furthermore, the input/output interface 53 outputs information output from the information output apparatus 1 to the outside. The device that captures a camera video is not limited to the camera 2, and may also be a mobile terminal such as a smart phone with the camera function or a tablet terminal.

As the program memory 51B, a non-transitory tangible computer-readable storage medium is used, for example, in which a random access non-volatile memory such as an HDD (hard disk drive) or an SSD (solid state drive) and a non-volatile memory such as a ROM are combined. The program memory 51B stores programs necessary to execute various types of control processing according to the embodiment.

As the data memory 52, a tangible computer-readable storage medium is used, for example, in which the above-described non-volatile memory and a volatile memory such as a RAM (random access memory) are combined. The data memory 52 is used to store various types of data acquired and generated during the procedure in which various types of processing are executed.

### (2) Software Configuration

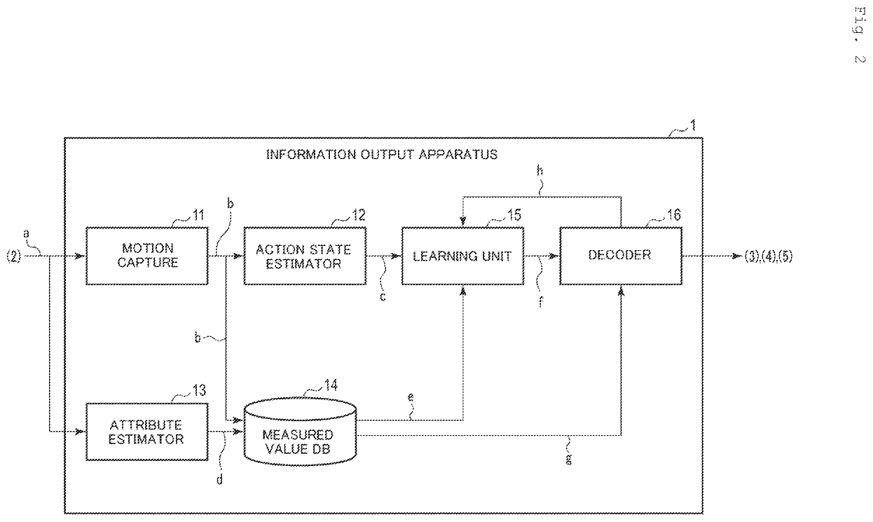

FIG. 2 is a diagram showing an example of the software configuration of the information output apparatus according to the embodiment of the present invention. FIG. 2 shows the software configuration of the information output apparatus 1 in association with the hardware configuration shown in FIG. 1.

As shown in FIG. 2, the information output apparatus 1 can be configured as a data processing apparatus including a motion capture 11, an action state estimator 12, an attribute estimator 13, a measured value database (DB) 14, a learning unit 15, and a decoder 16 as processing functional units realized by software.

The measured value database 14 and other various databases in the information output apparatus 1 shown in FIG. 2 can be configured using the data memory 52 shown in FIG. 1. Note that the measured value database 14 is not an essential constituent element in the information output apparatus 1, and it may be provided, for example, in an external storage medium such as a USB (universal serial bus) memory or a storage apparatus such as a database server arranged in a cloud.

The information output apparatus 1 is provided, for example, as a virtual robot interactive signage or the like that outputs image information or audio information to a pedestrian and induces the pedestrian to use a service.

The processing functional units of all of the motion capture 11, the action state estimator 12, the attribute estimator 13, the learning unit 15, and the decoder 16 described above are realized by causing the hardware processor 51A to read and execute programs stored in the program memory 51B. Note that some or all of these processing functional units may be realized in other various forms including integrated circuits such as an ASIC (application specific integrated circuit) or an FPGA (field-programmable gate array).

The motion capture 11 accepts input of depth video data and color video data regarding a pedestrian, which were captured by the camera 2 (a shown in FIG. 2).

The motion capture 11 detects face orientation data of the pedestrian and position data of the center of gravity of the pedestrian (hereinafter, it may be simply referred to as a position of a pedestrian) from the video data, and adds an ID (identification data) (hereinafter, an pedestrian ID) unique to the pedestrian to these detection results.

The motion capture 11 outputs the information after the addition as (1) a pedestrian ID, (2) a face orientation of the pedestrian corresponding to the pedestrian ID (hereinafter, it may be referred to as a face orientation of a pedestrian ID or a face orientation of a pedestrian), and (3) a position of a pedestrian corresponding to the pedestrian ID (hereinafter, it may be referred to as a position of a pedestrian ID or a position of a pedestrian), to the action state estimator 12 and the measured value database (b shown in FIG. 2).

The action state estimator 12 accepts input of the face orientation of the pedestrian, the position of the pedestrian, and the pedestrian ID, and estimates a current action state of the pedestrian to the agent such as a robot or a signage based on the input result.

The action state estimator 12 adds the pedestrian ID to the estimation result, and outputs the resultant as (1) a pedestrian ID and (2) a symbol expressing a state of a pedestrian corresponding to the pedestrian ID (hereinafter, it may be referred to as a state of a pedestrian or an estimation result of an action state of a pedestrian) to the learning unit 15 (c shown in FIG. 2).

The details of the procedure in which a face orientation of a pedestrian, a position of the pedestrian, and a pedestrian ID are input, and an action state of the pedestrian is estimated based on the input result are described, for example, in Japanese Patent Application Publication No. 2019-87175 (e.g., paragraphs [0102] to [0108]).

The attribute estimator 13 accepts input of the depth video and the color video from the motion capture 11, and estimates an attribute indicating a feature unique to the pedestrian such as the age and the sex based on the input video.

The attribute estimator 13 adds the pedestrian ID of the pedestrian to the estimation result, and outputs the resultant as (1) a pedestrian ID and (2) a symbol expressing an attribute of a pedestrian corresponding to the pedestrian ID (hereinafter, it may be referred to as an attribute of a pedestrian or an estimation result of an attribute of a pedestrian) to the measured value database 14 (d shown in FIG. 2).

The learning unit 15 accepts input of the pedestrian ID and the estimation result of the action state from the action state estimator 12, and reads and accepts input of (1) the pedestrian ID and (2) the symbol expressing the attribute of the pedestrian from the measured value database 14 (e shown in FIG. 2).

The learning unit 15 determines an action of the pedestrian, using the policy π according to the ε-greedy method, based on the pedestrian ID, the estimation result of the action state of the pedestrian, and the estimation result of the attribute of the pedestrian.

The learning unit 15 outputs (1) a symbol expressing the determined action, (2) an ID unique to the information (hereinafter, it may be referred to as an action ID), and (3) the pedestrian ID, to the decoder 16 (f shown in FIG. 2). The action is determined using a learning result through a learning algorithm.

The decoder 16 accepts input of (1) the pedestrian ID, (2) the action ID, and (3) the symbol expressing the determined action, from the learning unit 15 (f shown in FIG. 2), and reads and accepts input of (1) the pedestrian ID, (2) the face orientation of the pedestrian, (3) the position of the pedestrian, and (4) the symbol expressing the attribute of the pedestrian, from the measured value database 14 (g shown in FIG. 2).

Based on these input results, the decoder 16 outputs image information according to the determined action using the display 3, outputs audio information according to the determined action using the speaker 4, or outputs drive control information for driving an object to the actuator 5.

Hereinafter, an example of definitions of various types of data used in the learning unit 15 will be described. These pieces of data will be described later in detail.

Maximum number n of people that can be dealt with=6 [people]
State set S={S₁|i=0, 1, . . . , n−1}
Attribute set P={p₁|i=0, 1, . . . , n−1}
Action set A={aᵢⱼ|i=0, 1, . . . , n−1 j=0, 1, . . . , 4}
Action-merit function Q: Pⁿ×Sⁿ×A→R (Sⁿ: n^{-th} power of direct product of S)
Reward function r: Pⁿ×Sⁿ×A×Pⁿ×Sⁿ→R

The R means a value of the universal set of real numbers.

The description of the action-merit function Q means that the action-merit function Q is a function that, in response to input of an attribute set of n people and a state set of n people, outputs an action merit in the range of a real number.

The description of the reward function r means that the reward function r is a function that, in response to input of an attribute set of n people and a state set of n people, outputs a reward in the range of a real number.

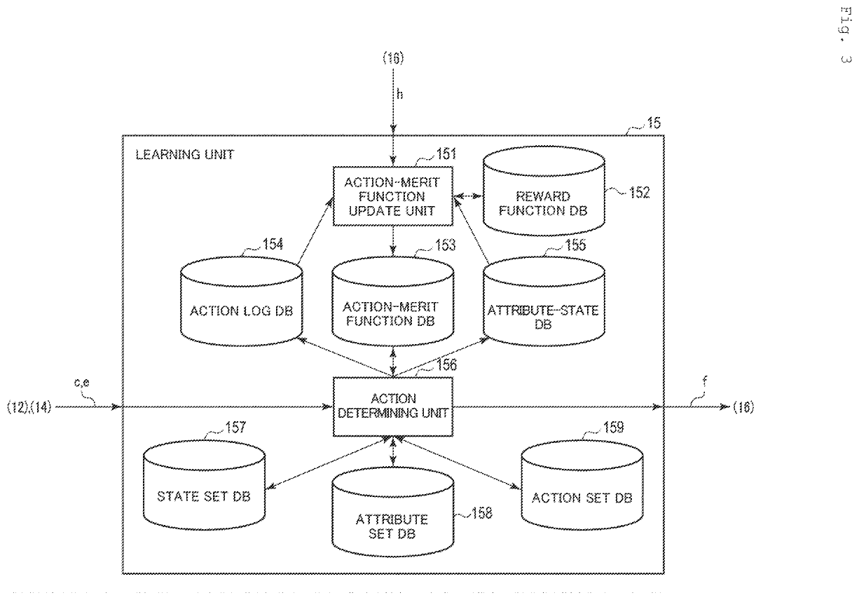

FIG. 3 is a diagram showing an example of the functional configuration of a learning unit of the information output apparatus according to the embodiment of the present invention.

As shown in FIG. 3, the learning unit 15 includes an action-merit function update unit 151, a reward function database (DB) 152, an action-merit function database (DB) 153, an action log database (DB) 154, an attribute-state database (DB) 155, an action determining unit 156, a state set database (DB) 157, an attribute set database (DB) 158, and an action set database (DB) 159. The various databases in the learning unit 15 can be configured using the data memory 52 shown in FIG. 1.

Next, action states will be described. In the embodiment, it is assumed that action states of pedestrians to an agent that does not move can be classified into seven states. In the embodiment, a set of definitions of the states is defined as being a state set S. The state set S is stored in advance in the state set database 157.

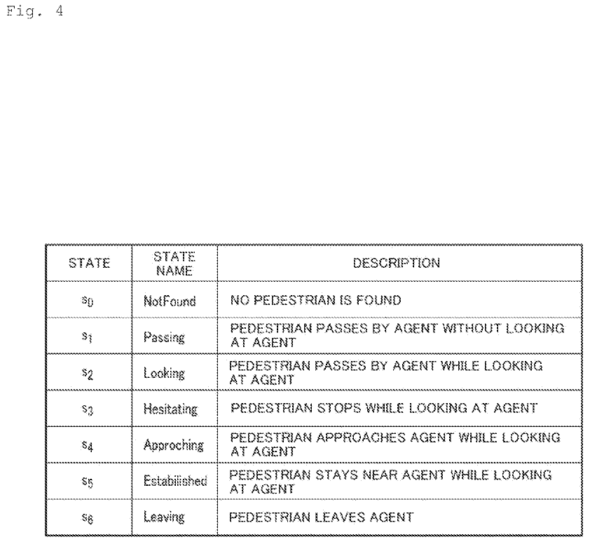

FIG. 4 is a table illustrating definitions of the state set S.

As shown in FIG. 4,

the state “so” with the state name “NotFound” means a state in which no pedestrian is found by the agent.

The state “s₁” with the state name “Passing” means a state in which a pedestrian passes by the agent without looking at the agent.

The state “s₂” with the state name “Looking” means a state in which a pedestrian passes by the agent while looking at the agent.

The state “s₃” with the state name “Hesitating” means a state in which a pedestrian stops while looking at the agent.

The action state “s₄” with the state name “Aproching” means a state in which a pedestrian approaches the agent while looking at the agent.

The action state “s₅” with the state name “Estabilished” means a state in which a pedestrian stays near the agent while looking at the agent.

The state “s₆” with the state name “Leaving” means a state in which a pedestrian leaves the agent.

Next, attributes will be described. In the embodiment, it is assumed that attributes of pedestrians can be classified into five attributes. These attributes are used to target children in families and the like. In the embodiment, a set of definitions of the attributes is defined as being an attribute set P. The attribute set P is stored in advance in the attribute set database 158.

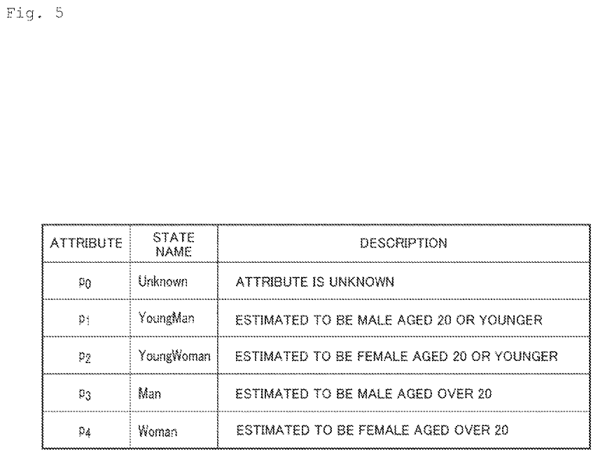

FIG. 5 is a table illustrating definitions of the attribute set P.

As shown in FIG. 5,

the attribute “p₀” with the state name “Unknown” means that an attribute of a pedestrian is unknown.

The attribute “p₁” with the state name “YoungMan” means that a pedestrian is estimated to be a male aged 20 or younger.

The attribute “p₂” with the state name “YoungWoman” means that a pedestrian is estimated to be a female aged 20 or younger.

The attribute “p₃” with the state name “Man” means that a pedestrian is estimated to be a male aged over 20.

The attribute “p₄” with the state name “Woman” means that a pedestrian is estimated to be a female aged over 20.

Next, the operations in which the information output apparatus 1 outputs image information or audio information will be described.

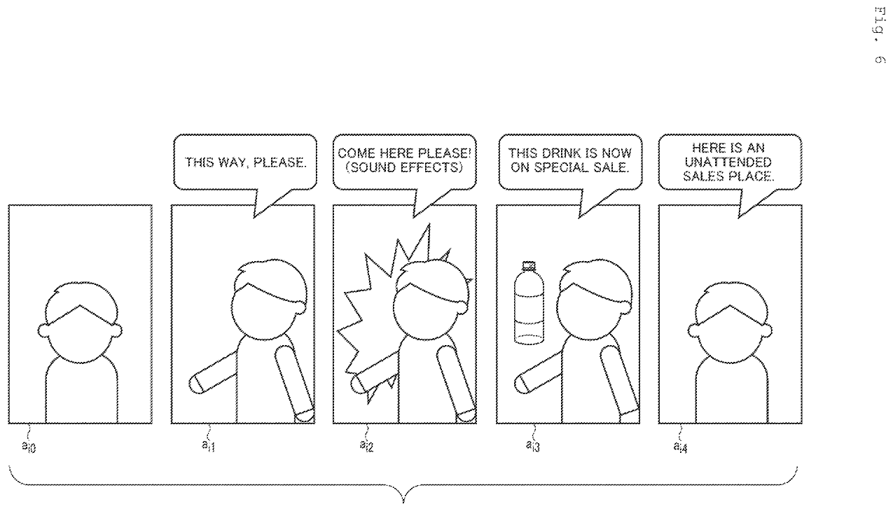

FIG. 6 is a diagram showing an example of operations that output image information or audio information, which can be performed by the information output apparatus 1 shown in FIG. 1 in response to detection of a pedestrian.

FIG. 6 shows five types of operations aᵢ₀, aᵢ₁, aᵢ₂, aᵢ₃, aᵢ₄ that can be performed by the information output apparatus 1, where j types of actions that can be performed by an agent to an i^{-th} pedestrian are taken as aᵢⱼ, and a set of definitions of actions that can be performed by the agent to a pedestrian is taken as an action set A (aᵢⱼ∈A). The action set A is stored in advance in the action set database 159.

The operation aᵢ₀ is an operation in which the information output apparatus 1 outputs image information of a person who is waiting, to the display 3.

The operation ail is an operation in which the information output apparatus 1 outputs image information of a person who guides an i^{-th} pedestrian while looking at and beckoning the pedestrian, to the display 3, and outputs audio information corresponding to the phrase “This way, please.” to talk to the pedestrian, from the speaker 4.

The operation aᵢ₂ is an operation in which the information output apparatus 1 outputs image information of a person who guides an i^{-th} pedestrian while looking at and beckoning the pedestrian with sound effects, to the display 3, and outputs (1) audio information corresponding to the phrase “Come here please!” to talk to the pedestrian and (2) audio information corresponding to sound effects to attract attention of the pedestrian, from the speaker 4. Note that the sound volume of the audio information corresponding to the sound effects is, for example, larger than that of the above-described two types of audio information corresponding to the phrases to talk to the pedestrian.

The operation aᵢ₃ is an operation in which the information output apparatus 1 outputs image information of a person who is recommending a product while looking at an i^{-th} pedestrian, to the display 3, and outputs audio information corresponding to the phrase “This drink is now on special sale.” to talk to the pedestrian, from the speaker 4.

The operation aᵢ₄ is an operation in which the information output apparatus 1 outputs image information of a person who is starting a service while looking at an i^{-th} pedestrian, to the display 3, and outputs audio information corresponding to the phrase “Here is an unattended sales place.” to talk to the pedestrian, from the speaker 4.

Next, the action-merit function Q will be described. Initial data of the action-merit function Q is determined in advance, and is stored in the action-merit function database 153.

For example, when it is intended to start a service in a state where there is one pedestrian near an agent, for example, assuming that states of pedestrians at a point of time are “S⁶ [symbol] s₅, s₀, s₀, s₀, s₀, s₀”, the action-merit function Q is “Q (p₁, p₀, p₀, p₀, p₀, p₀, s₅, s₀, s₀, s₀, s₀, s₀, a₀₄)=10.0”.

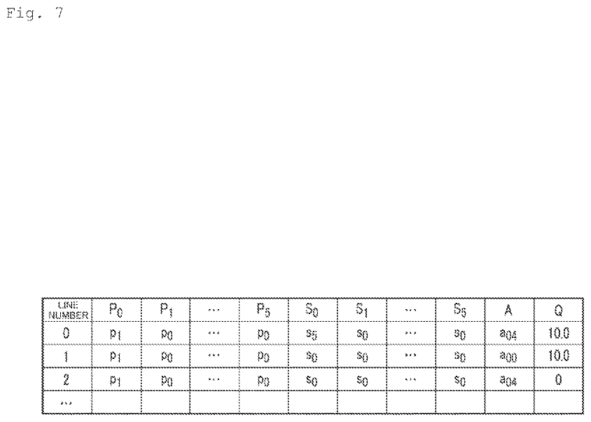

Since all inputs of the action-merit function are discrete values, the values of the definitions of the action-merit function Q can be expressed in the form of an action-merit table. FIG. 7 is a diagram showing an example of the configuration of an action-merit table in the form of a table. In the action-merit table shown in FIG. 7, attributes of 1^{-st} to 6^{-th} pedestrians are indicated as P₀, P₁, . . . , P₅, states of the 1^{-st} to 6^{-th} pedestrians are indicated as S₀, S₁, . . . S₅, an action is indicated as A, and a value indicating the magnitude of a merit of the action in terms of attracting pedestrians is indicated as Q. In this action-merit table, a combination of (1) an action for inducing a user to use a service, which is performed by an agent according to an attribute and an action of the pedestrian and (2) a value indicating the magnitude of a merit of the action is defined.

In the action-merit table shown in FIG. 7, the states of the 0^{-th} pedestrian are different between the 0^{-th} line and the 2^{-nd} line. The state of the 0^{-th} pedestrian in the 0^{-th} line in the action-merit table shown in FIG. 7 is s₅ (Estabilished), and thus a₀₄ (start a service) is defined as the action. On the other hand, the state of the 0^{-th} pedestrian in the 2^{-nd} line in the action-merit table shown in FIG. 7 is s₀ (NotFound), and thus a₀₀ (do nothing) is defined as the action.

The action determining unit 156 determines an action that maximizes the action-merit function at a fixed probability 1-E, using the policy π according to the ε-greedy method.

For example, it is assumed that a combination of attributes of six pedestrians estimated by the attribute estimator 13 is (p₁, p₀, p₀, p₀, p₀, p₀), and that a combination of states of the same six pedestrians estimated by the action state estimator 12 is (s₅, s₀, s₀, s₀, s₀, s₀).

At this time, the action determining unit 156 selects a line with the highest value of the action merit, for example, the 1^{-st} line shown in FIG. 7 with the Q 10.0, out of lines in which these combinations are defined, in the action-merit table stored in the action-merit function database 153. The action determining unit 156 determines an action corresponding to the action “a₀₀” defined in the selected line, as the action that maximizes the action-merit function.

Note that the action determining unit 156 determines an action to a pedestrian at random at a fixed probability E.

Next, the reward function r will be described. The reward function r is a function that determines a reward for the action determined by the action determining unit 156, and is determined in advance in the reward function database 152.

The reward function r is determined, for example, as in the following rules (1), (2), and (3), based on the role of attracting pedestrians on rule base and the user experience (in particular, usability). These rules are determined based on the action purpose to induce people to approach an agent because the role of the agent is to attract people.

Rule (1): If the state of a pedestrian changes toward the state s₅ as viewed from the state so within the range from so to s₅ of the state set S in response to the agent performing some action, that is, talking to the pedestrian, it is considered that the agent performed a preferable action from the viewpoint of its role, and a positive reward is given to the action.

Rule (2): If the state of a pedestrian changes toward the state so within the range from so to s₅ of the state set S in response to the agent talking to the pedestrian, it is considered that the agent performed a preferable action from the viewpoint of its role, and a negative reward is given to the action.

Rule (3): If the robot talks to a pedestrian who is passing by without looking at the robot, it is considered that the robot performed an action that caused displeasure to the user, and a negative reward is given to the action.

Rule (4): If the agent performs a talking action when there is no one, it is considered that the electric power related to the agent operation was wasted, and a negative reward is given to the action.

Rule (5): Children react to stimulations relatively sensitively, whereas adults react to stimulations relatively insensitively. Based on these aspects, if a pedestrian who was stimulated by the agent under the condition satisfying the rules (1) to (4) above is an adult, it is considered that a significant user experience was given to the pedestrian, and the absolute value of a reward value that is given according to the rules (1) to (4) above is doubled.

Default rule: If the action performed by the agent does not match any of the rules (1) to (5) above, no reward is given to the action.

The reward function r is expressed, for example, as Formula (1) below.

[Formula 1]

Function r(\vec{p}ₚᵣₑᵥᵢₒᵤₛ,\vec{s}ₚᵣₑᵥᵢₒᵤₛ,a,\vec{p}ₙₑₓₜ,\vec{s}ₙₑₓₜ) (1)

\vec{p}ₚᵣₑᵥᵢₒᵤₛ: Attribute of each pedestrian before action by agent

\vec{s}ₚᵣₑᵥᵢₒᵤₛ: State of each pedestrian before action by agent

a: Action by agent

\vec{p}ₙₑₓₜ: Attribute of each pedestrian after action by agent

\vec{s}ₙₑₓₜ: State of each pedestrian after action by agent

The determination of the output of the reward function r will be described as in (A) to (C) below. The output is determined by the action-merit function update unit 151 accessing the reward function database 152 and receiving a reward returned from the reward function database 152. It is also possible that the reward function database 152 itself has a function of setting a reward, and the set reward is output from the reward function database 152 to the action-merit function update unit 151.

(A) If a is a ᵢ₀, that is, if the agent does nothing (is waiting), the reward 0 is returned (the default rule is applied).

(B) If a is not a ᵢ₀, that is, if the agent talks to a pedestrian (is not waiting), the states of the pedestrian before and after the action by the agent are compared with each other, and (B-1) to (B-5) are performed.

(B-1) If the states of one or more pedestrians after the action by the agent change from the state before the action toward the state s₅ as viewed from the state so of the state set S, +1 is returned as a positive reward (the rule (1) is applied).

Note that, in the case in which the above-described condition for returning +1 is satisfied, if an attribute of a pedestrian before the action, relating to a state close to s₅ described above, is p₃ or p₄ in the attribute set P, that is, if the pedestrian is estimated to be aged over 20, +2 obtained by doubling +1 above (the rule (1) is applied) is returned as a reward (the rule (5) is applied).

(B-2) If the states of one or more pedestrians after the action by the agent change from the state before the action toward the state so of the state set S, −1 is returned as a negative reward (the rule (2) is applied).

Note that, in the case in which the above-described condition for returning −1 is satisfied, if an attribute of a pedestrian before the action, relating to a state close to so described above, is p₃ or p₄ in the attribute set P, that is, if the pedestrian is estimated to be aged over 20, −2 obtained by doubling −1 above (the rule (2) is applied) is returned as a reward (the rule (5) is applied).

(B-3) If all components of attributes of pedestrians are s₀ (NotFound) or s₁ (Passing), and the attributes of the pedestrians before and after the action have the same components, −1 is returned as a reward (the rule (3) is applied).

(B-4) If all components of attributes of pedestrians are so (NotFound), −1 is returned as a reward (the rule (4) is applied).

(B-5) If none of (B-1) to (B-4) is satisfied, 0 is returned as a reward (the default rule is applied).

In this manner, a reward for the action determined by the action determining unit 156 can be set.

Next, update (learning) of the action-merit function by the action-merit function update unit 151 will be described.

The action-merit function update unit 151 updates the value Q of the action merit in the action-merit table stored in the action-merit function database 153, using Formula (2) below. Accordingly, as described above, the value of the action merit can be updated based on a reward determined according to a change between the states of pedestrians before and after an action to the pedestrians.

$$\begin{matrix} [ Formula 2 ] & \\ Q ( {{p}^{->}}_{previous} , {{s}^{->}}_{previous} , a ) ← Q ( {{p}^{->}}_{previous} , {{s}^{->}}_{previous} , a ) + α [ r ( {{p}^{->}}_{previous} , {{s}^{->}}_{previous} , a , {{p}^{->}}_{next} , {{s}^{->}}_{next} ) + {γmax}_{t} Q ( {{p}^{->}}_{next} , {{s}^{->}}_{next} , t ) - Q ( {{p}^{->}}_{previous} , {{s}^{->}}_{previous} , a ) ] & ( 2 )\end{matrix}$$

In Formula (2), γ is a time discount rate (a rate that determines a magnitude at which a next optimal action by an agent is reflected). The time discount rate is, for example, 0.99.

In Formula (2), a is a learning rate (a rate that determines a magnitude at which an action-merit function is updated). The learning rate is, for example, 0.7.

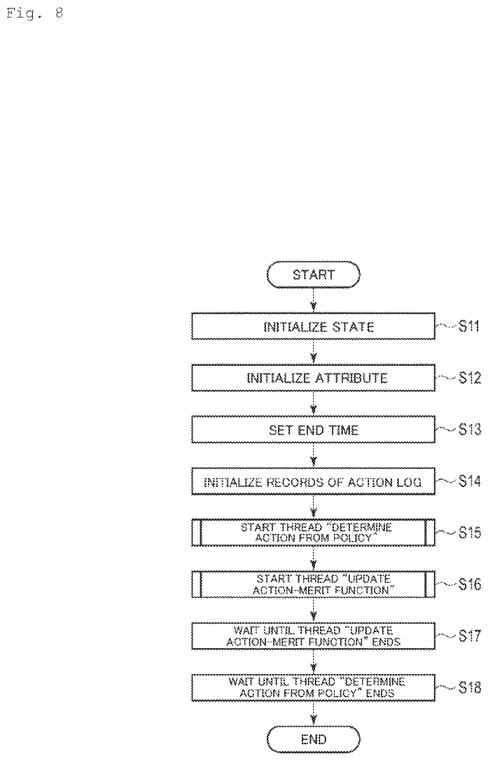

Next, the processing procedure by the learning unit 15 will be described. FIG. 8 is a flowchart illustrating an example of the processing operation by the learning unit.

The action determining unit 156 of the learning unit 15 inputs (1) an ID of a pedestrian, (2) a symbol expressing a state of the pedestrian ID, (3) an ID of a pedestrian, and (4) a symbol expressing an attribute of the pedestrian ID (c and e shown in FIGS. 2 and 3).

After the input, the action determining unit 156 reads (1) a definition of the state set S stored in the state set database 157, (2) a definition of the attribute set P stored in the attribute set database 158, and (3) a definition of the action set A stored in the action set database 159, and stores them in an unshown internal memory in the learning unit 15. The internal memory can be configured using the data memory 52.

The action determining unit 156 sets initial values of states of pedestrians, stored in the attribute-state database 155, based on the definition of the state set S (S11). In the initial state, it is assumed that there is no pedestrian near the agent, and the initial values of states of actions of the pedestrians are as in (3) below.

[Formula 3]

\vec{s}←(s₀,s₀,s₀,s₀,s₀,s₀) (3)

The action determining unit 156 sets initial values of attributes of pedestrians, stored in the attribute-state database 155, based on the definition of the attribute set P (S12). In the initial state, there is no pedestrian near the agent, and thus it is assumed that attributes are unknown, and the initial values of attributes of the pedestrians are as in (4) below.

[Formula 4]

\vec{p}←(p₀,p₀,p₀,p₀,p₀,p₀) (4)

The action determining unit 156 sets a variable T to a predetermined end time (T←end time) (S13).

The action determining unit 156 deletes all records of an action log stored in the action log database 154, thereby initializing the action log (S14). In a record of the action log, (1) an action ID, (2) a symbol expressing an action of an agent, (3) a symbol expressing an attribute of each pedestrian when an action is started, and (4) a symbol expressing state of each pedestrian when an action is started are associated with each other.

The action determining unit 156 calls a thread “determine action from policy” by reference to (5) below (S15). This thread is a thread regarding output to the decoder 16.

[Formula 5]

\vec{p},\vec{s},Action log,Function Q,T (5)

The action determining unit 156 calls a thread “update action-merit function” by reference to (5) (S16). This thread is a thread regarding learning by the action-merit function update unit 151. The action determining unit 156 waits until the thread “update action-merit function” ends (S17).

After the thread “update action-merit function” ends, the action determining unit 156 waits until the thread “determine action from policy” ends (S18). After the thread “determine action from policy” ends, the series of processing is ended.

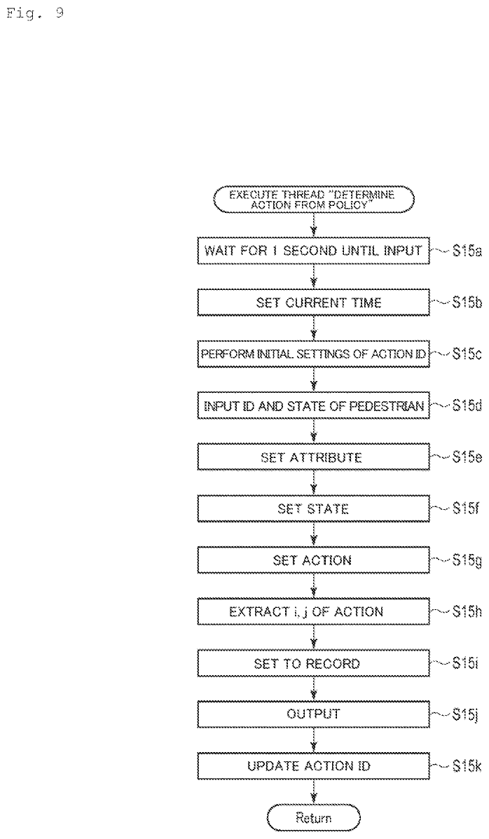

Next, the thread “determine action from policy” will be described in detail. FIG. 9 is a flowchart illustrating an example of the processing operation of a thread “determine action from policy” by the learning unit.

The action determining unit 156 repeats the following steps S15a to S15k until the current time is past the end time (t>T).

The action determining unit 156 waits for 1 second until all of an ID of a pedestrian, a symbol expressing a state of the pedestrian ID, and a symbol expressing an attribute of the pedestrian ID are input (S15a).

The action determining unit 156 sets a variable t to a current time (t←current time) (S15b).

The action determining unit 156 sets an initial value of an action ID to 0 (action ID←0) (S15c).

When an ID of a pedestrian, a symbol expressing a state of the pedestrian ID, and a symbol expressing an attribute of the pedestrian ID are input, the action determining unit 156 performs the following steps S15d to S15k.

When an ID of a pedestrian, a symbol expressing a state of the pedestrian ID, and a symbol expressing an attribute of the pedestrian ID are input, the action determining unit 156 substitutes the input result for a variable Input (Input←input) (S15d).

During the following steps S15e to S15k, the action determining unit 156 prohibits writing by other threads to (6) below, which is:

(a) an attribute and a state of each pedestrian, stored in the attribute-state database 155;
(b) an action log stored in the action log database 154; and
(c) an action-merit function stored in the action-merit function database 153.

[Formula 6]

\vec{p},\vec{s},Action log,Function Q (6)

The action determining unit 156 sets (7) below, using the ID of the pedestrian and the attribute of the pedestrian ID that have been input.

k←Input[“ID of pedestrian”] (7)

Subsequently, the action determining unit 156 sets (8) below for an attribute of each pedestrian, stored in the attribute-state database 155, using the ID of the pedestrian and the attribute of the pedestrian ID that have been input (S15e).

[Formula 7]

\vec{p}ₖ←Input[“Attribute of pedestrian”] (8)

The action determining unit 156 sets (9) below for a state of each pedestrian, stored in the attribute-state database 155, using the ID of the pedestrian and the state of the pedestrian ID that have been input (S15f).

[Formula 8]

\vec{s}ₖ←Input[“State of pedestrian”] (9)

The action determining unit 156 sets a variable a to an action selected using the policy π (a←action selected using the policy π) (S15g).

The action determining unit 156 extract values i, j indicating the type of the selected action with reference to the definitions of the above-described action set A (S15h).

The action determining unit 156 sets a new record of the action log as in (10) below, based on the currently set action ID, and the set results in S15e, S15f, and S15g (S15i). This record is added as the last record in the action log stored in the action log database 154.

[Formula 9]

Record←{“Action ID”:Action ID,“Action of agent”:a,“Attribute of each pedestrian:\vec{p},” “State of each pedestrian:\vec{s}”} (10)

The action determining unit 156 outputs the symbol a expressing the action set in S15g, the input value i of the pedestrian ID, and the currently set action ID (f shown in FIGS. 2 and 3) to the decoder 16 (output←(a, i, action ID)) (S15j).

The action determining unit 156 increments the currently set value of the action ID by 1 and updates the resultant (action ID←action ID+1) (S15k). It is assumed that inputs and records are held as an associative matrix.

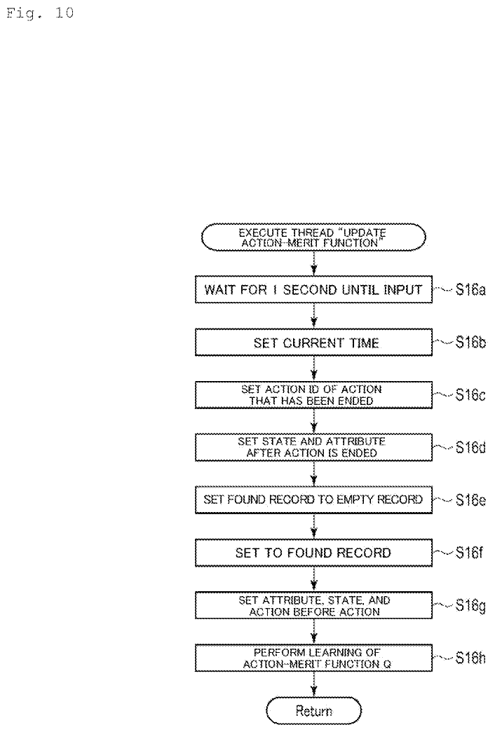

Next, the thread “update action-merit function” will be described in detail. FIG. 10 is a flowchart illustrating an example of the processing operation of a thread “update action-merit function” by the learning unit.

The action-merit function update unit 151 repeats the following steps S16a to S16h until the current time is past the end time (t>T).

The action-merit function update unit 151 waits for 1 second until “action ID of action that has been ended” (h shown in FIGS. 2 and 3) is input (S16a).

The action-merit function update unit 151 sets a variable t to a current time (t←current time) (S16b).

When “action ID of action that has been ended” is input, the action-merit function update unit 151 performs the following steps up to S16h.

When “an action ID of an action that has been ended” is input, the action-merit function update unit 151 substitutes the input result for a variable Input (Input←input).

During the following steps up to S16h, the action-merit function update unit 151 prohibits writing by other threads to (11) below, which is:
(a) an attribute and a state of each pedestrian, stored in the attribute-state database 155;
(b) an action log stored in the action log database 154; and (c) an action-merit function stored in the action-merit function database 153. This (11) is the same as (6) above.

[Formula 10]

\vec{p},\vec{s},Action log,Function Q (11)

The action-merit function update unit 151 sets the variable “action ID of action that has been ended” to the input “action ID of action that has been ended” (an action ID of an action that has been ended←Input[“action ID of action that has been ended”]) (S16c).

The action-merit function update unit 151 sets (12) and (13) below as a state and an attribute of each pedestrian after the action is ended, using the attribute and the state of the pedestrian stored in the attribute-state database 155 (S16d).

[Formula 11]

\vec{s}ₙₑₓₜ←\vec{s} (12)

\vec{p}ₙₑₓₜ←\vec{p} (13)

The action-merit function update unit 151 sets “found record” to an empty record, thereby performing initialization (found record←empty record) (S16e).

The action-merit function update unit 151 sets a variable to 0 (i←0), and, if i is smaller than the number of records of the action log stored in the action log database 154, the following step S16f is repeated.

The action-merit function update unit 151 sets the record to an i^{-th} record of the action log stored in the action log database 154 (record←i^{-th} record of action log). If “action ID of action that has been ended” set in S16c and “record “action ID””, which is an action ID of the set record, match each other, the action-merit function update unit 151 sets the “found record” to this record, and updates the set variable i by incrementing the variable by 1 (i←i+1) (S16f).

If “found record” is not an empty record, the action-merit function update unit 151 performs the following steps S16g and S16h.

The action-merit function update unit 151 sets (14) below for an attribute of each pedestrian before the action, in “found record”, sets (15) below for a state of each pedestrian before the action, in “found record”, and sets (16) below for a symbol expressing an action, in “found record” (S16g).

[Formula 12]

\vec{p}ₚᵣₑᵥᵢₒᵤₛ←Record “Attribute of each pedestrian” (14)

\vec{s}ₚᵣₑᵥᵢₒᵤₛ←Record “State of each pedestrian” (15)

a←Record “Action of agent” (16)

The action-merit function update unit 151 performs learning of the action-merit function, that is, so-called Q learning, using (17) below as an argument (S16h).

[Formula 13]

(\vec{p}ₚᵣₑᵥᵢₒᵤₛ,\vec{s}ₚᵣₑᵥᵢₒᵤₛ,a,\vec{p}ₙₑₓₜ,\vec{s}ₙₑₓₜ) (17)

As described above, with the information output apparatus according to the embodiment of the present invention, an action to a pedestrian is determined based on a pedestrian's state and attribute and an action-merit function, and a reward function is set based on a state of the pedestrian when the determined operation is performed, that is, information according to the operation is output. The information output apparatus updates the action-merit function such that a more proper action can be determined in consideration of the reward function.

Accordingly, when attracting a pedestrian, an agent can perform an action (can talk) to the pedestrian in a proper manner that is unlikely to cause displeasure to the pedestrian, and thus it is possible to increase the rate at which the agent successfully attracts the pedestrian. Accordingly, it is possible to properly induce the pedestrian to use a service.

Note that each method described in the embodiment can be stored, as a program (software means) that can be executed by a computer, in a recording medium, such as a magnetic disk (Floppy (registered trademark) disk, hard disk, etc.), an optical disc (CD-ROM, DVD, MO, etc.), or a semiconductor memory (ROM, RAM, flash memory, etc.), for example, or transmitted and distributed using a communication medium. Note that a program that is stored on the medium side includes a setting program for configuring, in the computer, software means (including not only an execution program but also a table or a data structure) to be executed by the computer. A computer that realizes the present apparatus executes the above-described processing by reading a program recorded in a recording medium, and in some cases, constructing software means following a setting program, and as a result of operations being controlled by the software means. Note that a recording medium mentioned in the present specification is not limited to a recording medium that is to be distributed, but also includes a storage medium, such as a magnetic disk, a semiconductor memory, etc., that is provided in a computer or a device connected to the computer via a network.

Note that the present invention is not limited to the above-described embodiment, and various alterations can be made within a scope not departing from the gist of the present invention when the present invention is implemented. Furthermore, in implementation of embodiments, the embodiments can be appropriately combined, and in such a case, combined effects can be achieved. Furthermore, the above-described embodiment includes various inventions, and various inventions can be extracted by combining those selected from a plurality of disclosed constituent elements. For example, even if some constituent elements are omitted from all constituent elements shown in the embodiments, a configuration obtained by omitting these constituent elements can be extracted as an invention so long as the issues can be solved and the effects can be achieved.
Reference Document [1] Yasunori Ozaki, Tatsuya Ishihara, Narimune Matsumura, and Tadashi Nunobiki, “Prediction of the decision-making that a pedestrian talks with a receptionist robot and Quantification of mental effects on the pedestrian”, CNR 2018
[2] ISO 9241-210
[3] ISO 9241-11
[4] Human Attribute Recognition by Deep Hierarchical Contexts, http://mmlab.ie.cuhk.edu.hk/projects/WIDERAttribute.html
[5] Introduction of features of OKAOR Vision, https://plus-sensing.omron.co.jp/technology/detail/

### REFERENCE SIGNS LIST

1 Information output apparatus
11 Motion capture
12 Action state estimator
13 Attribute estimator
14 Measured value database
15 Learning unit
16 Decoder
151 Action-merit function update unit
152 Reward function database
153 Action-merit function database
154 Action log database
155 Attribute-state database
156 Action determining unit
157 State set database
158 Attribute set database
159 Action set database

1. An information output apparatus comprising:
a processor; and
a storage medium having computer program instructions stored thereon, when executed by the processor, perform to:
detect face orientation data and position data regarding a user, based on video data regarding the user;
estimate an attribute indicating a feature unique to the user, based on the video data;
estimate a current action state of the user, based on the face orientation data and the position data detected;
a storage unit having stored therein an action-merit table that defines combinations each composed of an action for inducing a user to use a service according to an attribute and an action state of the user, and a value indicating a magnitude of a merit of the action; determination means for determining an action for inducing the user to use a service with a high value indicating the magnitude of the merit of the action, out of combinations corresponding to the attribute and the state, in the action-merit table stored in the storage unit;
output information according to the action;
set, after the information is output, a reward value for the determined action, based on action states of the user estimated before and after the output; and update the value of the action merit in the action-merit table, based on the set reward value.

2. The information output apparatus according to claim 1, wherein the computer program instructions further perform to set a positive reward value for the determined action, in a case in which a change from the action state of the user before the information is output to the action state of the user after the information is output is a change indicating that the output information is effective for the induction, and sets a negative reward value for the determined action, in a case in which a change from the action state of the user before the information is output to the action state of the user after the information is output is a change indicating that the output information is not effective for the induction.

3. The information output apparatus according to claim 2, wherein the attribute includes an age of the user, and in a case in which the age of the user included in the attribute when the information is output is over a predetermined age, changes the set reward value to a value increased by an absolute value of the value.

4. The information output apparatus according to claim 1, wherein the computer program instructions further perform to output at least one of image information, audio information, and drive control information for driving an object according to the action determined by the determination m ns.

5. An information output method that is performed by an information output apparatus, comprising:
detecting face orientation data and position data regarding a user, based on video data regarding the user; estimating an attribute indicating a feature unique to the user, based on the video data; estimating a current action state of the user, based on the detected face orientation data and position data; in an action-merit table that is stored in a storage apparatus and that defines combinations each composed of an action for inducing a user to use a service according to an attribute and an action state of the user, and a value indicating a magnitude of a merit of the action, determining an action for inducing the user to use a service with a high value indicating the magnitude of the merit of the action, out of combinations corresponding to the estimated attribute and state; outputting information according to the determined action; setting, after the information is output according to the determined action, a reward value for the determined action, based on estimated action states of the user before and after the output; and updating the value of the action merit in the action-merit table, based on the set reward value.

6. A non-transitory computer-readable medium having computer-executable instructions that, upon execution of the instructions by a processor of a computer, cause the computer to function as the information output apparatus according to claim 1.
